(19) United States
(12) Patent Application Publication
(10) Pub. No.: US 2012/0314449 A1
(43) Pub. Date: Dec. 13, 2012

(54) LIGHTING ASSEMBLY

(75) Inventors: Timothy A. McCollum, Avon Lake, OH (US); Jeffery R. Parker, Richfield, OH (US)

(73) Assignee: RAMBUS INC., Sunnyvale, CA (US)

(21) Appl. No.: 13/490,609

(22) Filed: Jun. 7, 2012

Related U.S. Application Data
(60) Provisional application No. 61/494,939, filed on Jun. 9, 2011.

(51) Int. Cl. F21V 8/00; F21V 7/00

(52) U.S. Cl. 362/602; 362/608; 362/609

(57) ABSTRACT

A lighting assembly includes a transparent light guide having first and second major surfaces and a light input edge, and is configured to propagate light by total internal reflection. A light source located adjacent the light input edge is selectively operable to edge light the light guide. First light extracting elements at the first major surface are configured to extract light through the first major surface with a first light ray angle distribution. Second light extracting elements at the first major surface are configured to extract light through the second major surface with a second light ray angle distribution. The light extracted through the second major surface reduces visibility at viewing angles within a defined viewing angle range through the lighting assembly from the second major surface of the light guide greater than the reduction in visibility through the lighting assembly from the first major surface of the light guide.

### RELATED APPLICATION DATA

This application claims the benefit of U.S. Provisional Patent Application No. 61/494,939, filed Jun. 9, 2011, the disclosure of which is incorporated herein by reference in its entirety.

### BACKGROUND

Energy efficiency has become an area of interest for energy consuming devices. One class of energy consuming devices is lighting assemblies. Light emitting diodes (LEDs) show promise as energy efficient light sources for lighting assemblies. But light output distribution is an issue for lighting assemblies that use LEDs or similar light sources.

### BRIEF DESCRIPTION OF THE DRAWINGS

FIGS. 1 and 2 are schematic views showing parts of an exemplary lighting assembly.

FIGS. 3-6 are schematic side views showing parts of embodiments of a light guide.

FIGS. 7A-7B are schematic views showing parts of another embodiment of a lighting assembly.

FIGS. 8A-8B are schematic views showing parts of another embodiment of a lighting assembly.

FIGS. 9A-9B are schematic views showing parts of another embodiment of a lighting assembly.

FIGS. 10-12 are schematic views showing parts of other embodiments of a lighting assembly.

FIG. 13 is a schematic view of an exemplary floor plan showing an application of a lighting assembly as a wall panel.

FIG. 14 is a schematic view of an exemplary floor plan showing an application of a lighting assembly as a window.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments.

A lighting assembly includes a transparent light guide and a light source. The light guide includes a first major surface, a second major surface opposite the first major surface, and a light input edge. The light guide is configured to propagate light by total internal reflection. The light source is located adjacent the light input edge and is selectively operable to edge light the light guide with visible light. First light extracting elements are at the first major surface of the light guide. The first light extracting elements are configured to extract light through the first major surface with a first light ray angle distribution directed away from the light input edge and the first major surface. Second light extracting elements are at the first major surface of the light guide. The second light extracting elements are configured to extract light through the second major surface with a second light ray angle distribution directed away from the second major surface and predominantly within a defined viewing angle range relative to the second major surface. The light extracting elements are configured such that light emitted from the light source and extracted from the light guide through the second major surface reduces visibility, at viewing angles within the viewing angle range relative to the second major surface, through the lighting assembly from the second major surface of the light guide compared with the visibility when the light guide is not illuminated by the light source. The light extracted from the light guide through the second major surface reduces the visibility, at viewing angles within the viewing angle range relative to the second major surface, through the lighting assembly from the second major surface of the light guide by more than the light extracted through the first major surface reduces visibility, at a normal viewing angle relative to the first major surface, through the lighting assembly from the first major surface of the light guide. The lighting assembly is described in greater detail herein with reference to the various embodiments illustrated in the figures.

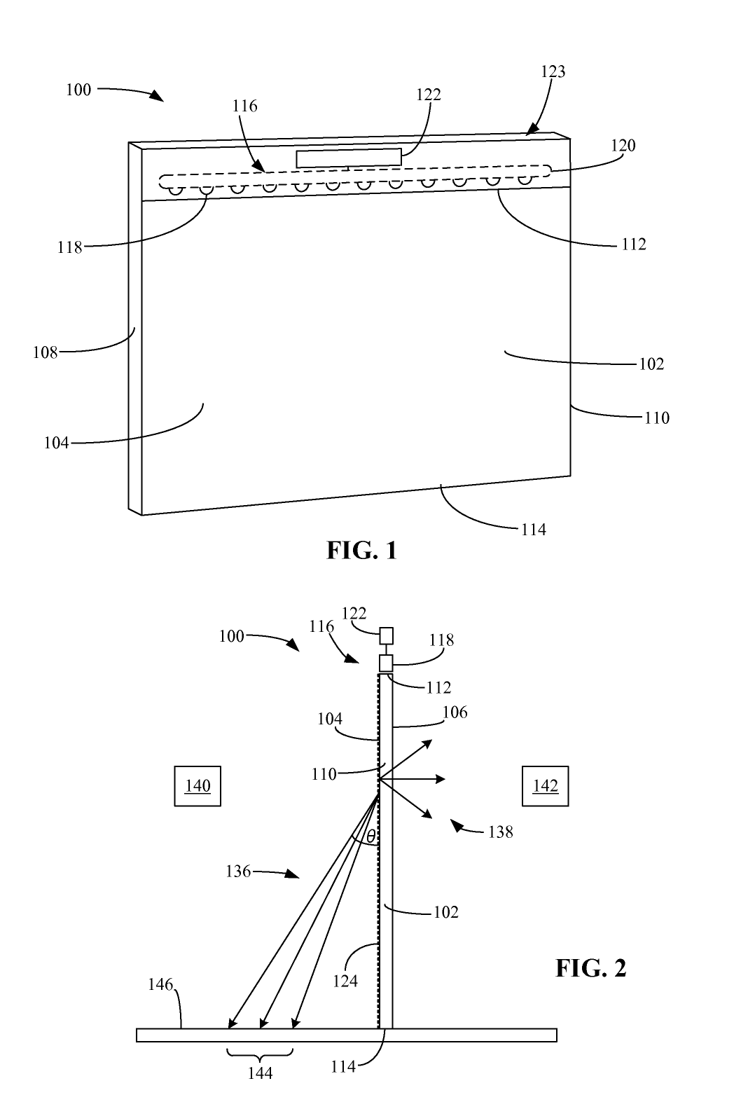

With reference to FIGS. 1 and 2, the lighting assembly 100 includes a light guide 102 and a light source assembly 116. The light guide 102 is a solid article made from a transparent material, for example, acrylic, polycarbonate, glass, or other appropriate material. The light guide 102 may also be a multi-layer light guide having two or more layers that may differ in refractive index. The light guide 102 includes a first major surface 104 and a second major surface 106 opposite the first major surface 104. The light guide 102 is configured to propagate light by total internal reflection between the first major surface 104 and the second major surface 106.

The light guide 102 has at least one edge, the total number of edges depending on the configuration of the light guide 102. In the case where the light guide 102 is rectangular (e.g., as shown in FIG. 1), the light guide 102 has four edges 108, 110, 112, 114 (e.g., side edges 108, 110 and end edges 112, 114). In other embodiments, the light guide 102 has a different shape, and the total number of edges is different. Depending on the geometry of the light guide 102, each edge may be straight or curved, and adjacent edges may meet at a vertex or join in a curve.

Light emitted from the light source assembly 116 is directed toward the end edge 112 that will now be referred to as a light input edge 112.

The length and width dimensions of each of the major surfaces 104, 106 are much greater, typically ten or more times greater, than the thickness of the light guide 102. The thickness is the dimension of the light guide 102 in a direction orthogonal to the major surfaces 104, 106. In the rectangular embodiment, the length (measured from light input edge 112 to end edge 114) and the width (measured from side edge 108 to side edge 110) of each of the major surfaces 104, 106 are both much greater than the thickness of the light guide 102. The thickness of the light guide 102 may be, for example, about 0.1 millimeters (mm) to about 10 mm.

In the illustrated embodiment, the major surfaces 104, 106 are planar (i.e., the major surfaces 104, 106 of the light guide 102 are not curved). In other embodiments, at least a portion of the major surfaces 104, 106 of the light guide 102 is curved in one or more directions. In one example, the intersection of the light input edge 112 and one of the major surfaces 104, 106 defines a first axis, and at least a portion of the light guide 102 curves about an axis orthogonal to the first axis. In another example, at least a portion of the light guide 102 curves about an axis parallel to the first axis.

In the example shown, the light source assembly 116 includes one or more light sources 118 positioned adjacent the light input edge 112 and selectively operable to edge light the light guide 102. Each light source 118 is typically embodied as one or more solid-state devices.

Exemplary light sources include such solid state devices as LEDs, laser diodes, and organic LEDs (OLEDs). In an embodiment where the light source 118 includes one or more LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light). In one embodiment, the light source 118 emits light with no operably-effective intensity at wavelengths greater than 500 nanometers (nm) (i.e., the light source 118 emits light at wavelengths that are predominantly less than 500 nm). In such embodiments, phosphors (not shown) convert at least part of the light emitted by the light source 118 to longer-wavelength visible light so that the light guide 102 can be regarded as being edge lit with visible light. In some embodiments, the light sources 118 have the same nominal spectrum. In other embodiments, at least some of the light sources 118 have spectra different from each other (e.g., light sources with different spectra are located (e.g., alternately located) along the light source assembly 116).

Although not illustrated in detail, the light source assembly 116 also includes structural components to retain the light sources 118. In one embodiment, the light sources 118 are mounted to a printed circuit board (PCB) 120.

The light source assembly 116 may additionally include components for controlling and driving the light sources 118. In one example, controller 122 is configured to control the illumination state of the light sources 118 (i.e., whether the light sources 118 emit or do not emit light). In some embodiments, the controller 122 is further configured to adjustably control the light sources 118 to increase or decrease the intensity of light emitted from the light sources 118 (i.e., dim or brighten the light sources 118). The controller 122 may control the light sources 118 in accordance with a user input from, for example, a switch (not shown), a knob (not shown), a dial (not shown), or another suitable device, and/or an input from, for example, one or more sensors (not shown) or an external controller (not shown).

The lighting assembly 100 may additionally include a housing 123 for retaining the light source assembly 116 and the light guide 102. The housing 123 may retain a heat sink or may itself function as a heat sink. In some embodiments, the housing 123 is configured to mount the lighting assembly 100 in an opening defined in a structure such as a wall, a cubicle wall, a roof, a ceiling, a window, etc., that retains and supports the lighting assembly. In other examples, the lighting assembly 100 is attached to a suitable structural member such as a floor, a wall, or a ceiling that retains and supports the lighting assembly 100. Electrical power is supplied to the lighting assembly 100 through appropriate conductors that in some cases may form part of or pass through the housing 123.

The light guide 102 includes light extracting elements 124. In the examples shown, the light extracting elements are in or on the first major surface 104. Light extracting elements 124 that are in or on the first major surface 104 will be referred to as being “at” the major surface 104. In other examples, the light extracting elements are within the light guide 102. The reference numeral 124 will be generally used to collectively refer to the different embodiments of light extracting elements. Each light extracting element functions to disrupt the total internal reflection of the propagating light that is incident on the light extracting element. The light extracting elements 124 at the first major surface 104 are configured to extract light from the light guide 102 through one or both of the major surfaces 104, 106. In one embodiment, the light extracting elements 124 at the first major surface 104 reflect light toward the second major surface 106 so that the light exits the light guide 102 through the second major surface 106. Additionally or alternatively, the light extracting elements 124 at the first major surface 104 transmit light so that the light exits the light guide 102 through the first major surface 104. In another embodiment, the light extracting elements 124 reflect a portion of the light incident thereon toward the second major surface 106 and refract another portion of the light, typically the remainder of the light, incident thereon through the first major surface 104. Such light extracting elements will be referred to as ray-splitting light extracting elements.

Exemplary light extracting elements 124 include light-scattering elements, which are typically features of indistinct shape or surface texture, such as printed features, ink jet printed features, selectively-deposited features, chemically etched features, laser etched features, and so forth. Other exemplary light extracting elements 124 include features of well-defined shape, such as V-grooves, lenticular grooves, and features of well-defined shape that are small relative to the linear dimensions of the major surfaces 104, 106, which are referred to herein as micro-optical elements. The smaller of the length and width of a micro-optical element is less than one-tenth of the longer of the length and width of the light guide 102 and the larger of the length and width of the micro-optical element is less than one-half of the smaller of the length and width of the light guide. The length and width of the micro-optical element is measured in a plane parallel to the major surface 104, 106 of the light guide 102 for flat light guides or along a surface contour for non-flat light guides 102.

Micro-optical elements are shaped to predictably reflect or refract light. However, one or more of the surfaces of the micro-optical elements may be modified, such as roughened, to produce a secondary effect on light output. Exemplary micro-optical elements are described in U.S. Pat. No. 6,752,505 and, for the sake of brevity, are not described in detail in this disclosure. The micro-optical elements may vary in one or more of size, shape, depth or height, density, orientation, slope angle or index of refraction such that a desired light output from the light guide is obtained.

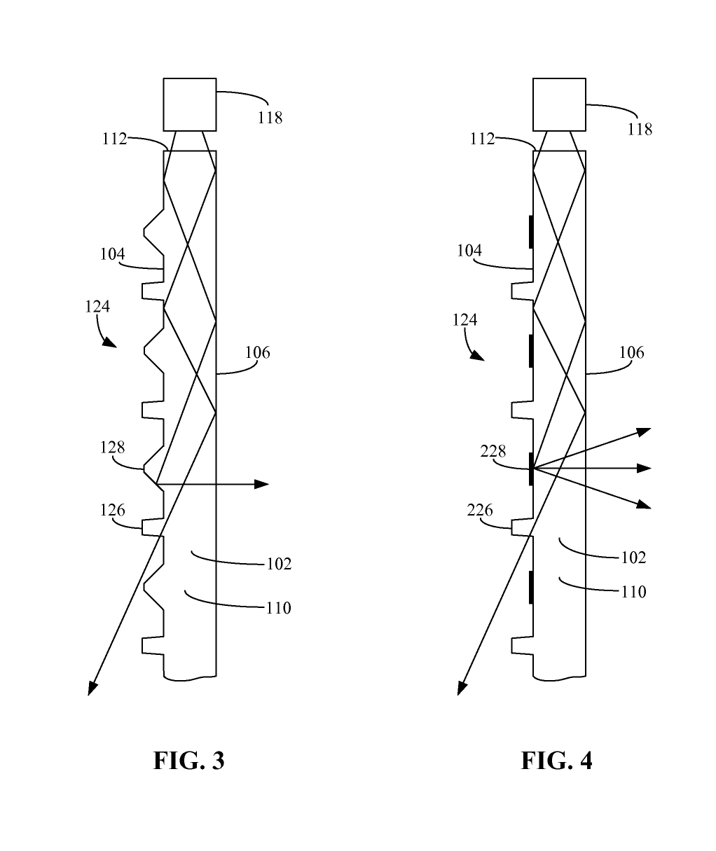

FIGS. 3-5 show exemplary embodiments of light extracting elements 124 at the first major surface 104 of the light guide 102. The light extracting elements 124 are configured to extract light through the major surfaces 104, 106 of the light guide 102.

In the embodiment of FIG. 3, light extracting elements 126 and light extracting elements 128 are different micro-optical elements. Light extracting elements 126 are configured to extract light through the first major surface 104 by refraction in a direction away from the light input edge 112 and the first major surface 104; and light extracting elements 128 are configured to extract light through the second major surface 106 by reflection in a direction away from the second major surface 106. Light propagating by total internal reflection in the light guide 102 that is incident on the light extracting elements 126 is refracted through the first major surface 104. Light propagating by total internal reflection in the light guide 102 that is incident on the light extracting elements 128 is reflected toward and extracted through the second major surface 106.

In the embodiment of FIG. 4, light extracting elements 226 are micro-optical elements and light extracting elements 228 are diffusely reflective elements. Light extracting elements 226 are configured to extract light through the first major surface 104 by refraction in a direction away from the light input edge 112 and the first major surface 104; and light extracting elements 228 are configured to extract light through the second major surface 106 by reflection in a direction away from the second major surface 106. Light propagating by total internal reflection in the light guide 102 that is incident on the light extracting elements 226 is refracted through the first major surface 104. Light propagating by total internal reflection in the light guide 102 that is incident on the light extracting elements 228 is diffusely reflected toward and extracted through the second major surface 106.

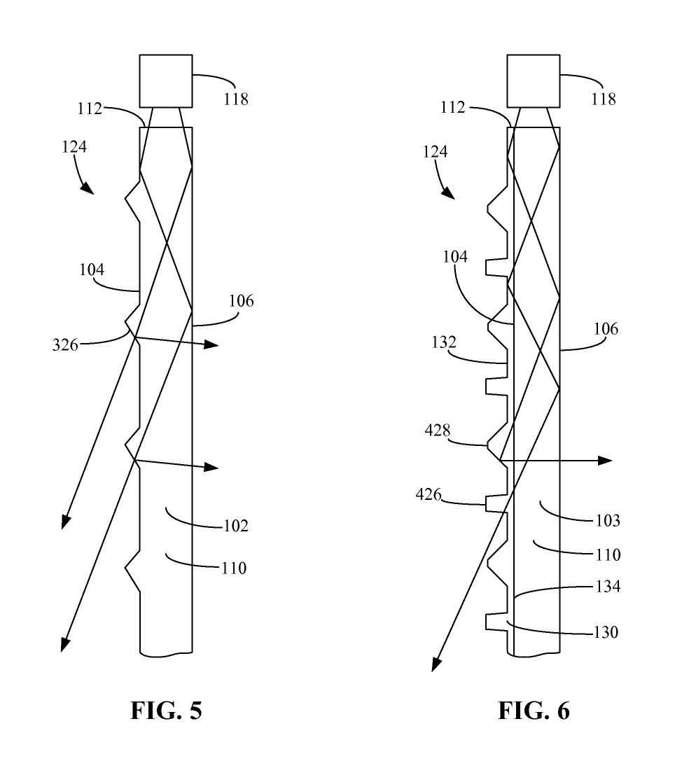

In the embodiment of FIG. 5, light extracting elements 326 are ray-splitting light extracting elements embodied as micro-optical elements. Light extracting elements 326 are configured to extract a portion of light incident thereon through the first major surface in a direction away from the light input edge 112 and the first major surface 104 by refraction; and to extract another portion of light, typically the remainder of the light, incident thereon through the second major surface 106 in a direction away from the second major surface 106. Light propagating by total internal reflection in the light guide 102 that is incident on the light extracting elements 326 is partially refracted through the first major surface 104 and partially reflected toward and extracted through the second major surface 106.

Light guides having light extracting elements 124 are typically formed by a process such as stamping, molding, embossing, extruding, laser etching, chemical etching, or another suitable process. Light extracting elements 124 may also be produced by depositing elements of curable material on the light guide 102 and curing the deposited material using heat, UV-light or other radiation. The curable material can be deposited by a process such as printing, ink jet printing, screen printing, or another suitable process.

FIG. 6 shows an embodiment in which the lighting assembly 100 includes a slab light guide 103 and a light extracting member 130 optically bonded to the first major surface 104 of the slab light guide 103. The light extracting elements 124 are at a first major surface 132 of the light extracting member 130 remote from the second major surface 134 that is bonded to the first major surface 104 of the slab light guide 103. In some implementations, the light extracting member 130 is embodied as a film optically bonded to the first major surface 104 of the slab light guide 103 using a resin or adhesive. The first major surface 104 of the slab light guide 103 is specularly transmissive (i.e., first major surface 104 lacks an optical modifying characteristic) even though specularly transmissive material refracts light that passes through a surface of the material at a non-zero angle of incidence. Light propagating in the slab light guide 103 exits the slab light guide 103 through the first major surface 104 and enters the light extracting member 130 through the second major surface 134 of the light extracting member 130. Light extracting elements 426 at the first major surface 132 of the light extracting member 130 are configured to extract light received through the second major surface 134 of the light extracting member 130 by refraction in a direction away from the light input edge 112 and the first major surface 132. Second light extracting elements 428 at the first major surface 132 of the light extracting member 130 are configured to extract light by reflection through the second major surface 134 of the light extracting member 130 and the first major surface 104 and the second major surface 106 of the slab light guide 103 in a direction away from the second major surface 106.

The light extracting elements 124 are configured to extract light in a defined light ray angle distribution. In this disclosure, the term light ray angle distribution is used to describe the variation of the intensity of light with ray angle (typically a solid angle) over a defined range of light ray angles. Using variations in the light extracting elements 124, light extracted through the major surfaces 104, 106 can have different respective light ray angle distributions.

With continued reference to FIG. 2, the light extracting elements 124 are configured such that light is extracted through the first major surface 104 of the light guide 102 with a light ray angle distribution 136, and such that light is extracted through the second major surface 106 of the light guide 102 with a light ray angle distribution 138.

The lighting assembly 100 has a defined viewing angle range relative to the second major surface 106 of the light guide 102. The viewing angle range relative to the second major surface 106 is the range of viewing angles relative to the normal to the second major surface 106 of the light guide 102 within which light emitted from the light source assembly 116 and extracted through the second major surface 106 of the light guide 102 reduces the visibility of objects located on the other side of the lighting assembly 100.

In a typical application, the viewing angle range of the lighting assembly 100 is a defined angular range relative to a nominal viewing angle normal to the second major surface 106 of the light guide 102 (or a portion of the major surface 106). However, in applications having a nominal viewing angle that is not normal to the second major surface 106 of the light guide 102, the viewing angle range is a defined solid angular range relative to such non-normal nominal viewing angle. The nominal viewing angle is non-normal in such applications as where the lighting assembly 100 is mounted above the average person's eye level. In an example, the viewing angle range is from −45° to +45° relative to the normal to the second major surface 106. In another example, the viewing angle range is from −30° to +60° relative to the normal to the second major surface 106. In the examples set forth above, a positive angle is an angle having a first vector component away from the light source assembly 116 along the normal to the second major surface 106 and a second vector component away from the light source assembly 116 along the plane defined by the second major surface 106.

The light ray angle distribution 138 is directed away from the second major surface 106 and is predominantly within the viewing angle range of the lighting assembly 100. A light ray angle distribution predominantly within the viewing angle range has predominant intensities at ray angles throughout the viewing angle range. The light ray angle distribution 138 typically has a wider range of ray angles than light ray angle distribution 136. In one example, light ray angle distribution 138 has operably effective intensities at ray angles throughout a range from −45° to +45° relative to the normal to the second major surface 106. In another example, light ray angle distribution 138 has operably effective intensities at ray angles throughout a range from −30° to +60° relative to the normal to the second major surface 106. The light ray angle distribution 138 is predominantly closer to normal to the second major surface 106 than the light ray angle distribution 136 is to normal to the first major surface 104.

The light extracted through the second major surface 106 of the light guide 102 reduces visibility through the light guide 102 from the second major surface 106 at viewing angles relative to the second major surface 106 within the viewing angle range. In other embodiments, the stray light additionally extracted through the second major surface 106 of the light guide 102 reduces visibility through the light guide 102 from the second major surface 106 at viewing angles relative to the second major surface 106 outside the viewing angle range.

The light ray angle distribution 136 is directed away from the light input edge 112 and the first major surface 104, and has predominant intensities at low ray angles relative to the first major surface 104. In this disclosure, the term low ray angle is used to describe a ray angle less than or equal to an angle θ relative to the first major surface. In one example, the angle θ is about 45° relative to the first major surface 104 in a direction away from the light input edge 112. In another example, the angle θ is about 30° relative to the first major surface 104 in a direction away from the light input edge 112. In yet another example, the angle θ is about 15° relative to the first major surface 104 in a direction away from the light input edge 112.

Light extracted through the first major surface 104 is directed away from the light guide 102 at low ray angles that are outside a normal viewing angle relative to the first major surface 104. A normal viewing angle relative to a given surface is a viewing angle along the normal to the surface. The light extracted through the first major surface 104 having the light ray angle distribution 136 does not reduce visibility through the light guide 102 at the normal viewing angle relative to the first major surface 104. However, in some embodiments, some reduction in visibility does occur due to stray light extracted through the first major surface 104 at ray angles outside the light ray angle distribution 136 and closer to the normal to the first major surface 104. Furthermore, the light extracted through the first major surface 104 of the light guide 102 reduces visibility through the lighting assembly 100 from the first major surface 104 at viewing angles relative to the first major surface 104 within the light ray angle distribution 136.

Control over illumination of the light guide 102 (e.g., via controller 122) provides for selective one-way viewing through the lighting assembly 100. When the light guide 102 is not illuminated, the light guide 102 is transparent and visibility through the lighting assembly 100 from the first major surface 104 and from the second major surface 106 is not reduced. The light extracting elements 124 are configured such that, during illumination of the light guide 102, visibility through the lighting assembly 100 from the second major surface 106 of the light guide 102 is reduced at viewing angles within the viewing angle range relative to the second major surface 106 of the light guide 102. Moreover, the reduction in visibility from the second major surface 106 is greater than the reduction in visibility through the lighting assembly 100 from the first major surface 104 of the light guide 102.

This disclosure uses the terms first side and second side to describe locations of an object and a viewer relative to the lighting assembly 100. In the embodiment illustrated in FIG. 2, an object or a viewer on the first side of the lighting assembly 100 faces the first major surface 104 of the light guide 102, whereas an object or a viewer on the second side of the lighting assembly 100 faces the second major surface 106 of the light guide 102.

In an example, when the light guide 102 is not illuminated, an object 140 on the first side of the lighting assembly 100 is visible through the light guide 102 when viewed from the second side of the lighting assembly 100; and an object 142 on the second side of the lighting assembly 100 is visible through the light guide 102 when viewed from the first side of the lighting assembly 100. The light extracting elements 124 are configured such that, when the light guide 102 is illuminated, the object 140 on the first side of the lighting assembly 100 is not visible through the light guide 102 when viewed at a viewing angle within the viewing angle range relative to the second side of the lighting assembly 100. However, the object 142 on the second side of the lighting assembly 100 is visible through the light guide 102 when viewed at a normal viewing angle relative to the first side of the lighting assembly 100. In some embodiments and/or under certain ambient lighting conditions, the object 140 is not rendered invisible when the light guide 102 is illuminated, but the visibility of the object 140 significantly reduced.

In some embodiments, the light extracted through the first major surface 104 having the light ray angle distribution 136 is incident on a region 144 of a target surface 146. In such an embodiment, the light extracting elements 124 are configured such that the light extracted through the first major surface 104 is directed toward the region 144 of the target surface 146. The target surface 146 may be, for example, a desk, table, floor, work surface, or another surface or object.

In other embodiments, one or more optical adjusters (not shown) are located adjacent one or both of the major surfaces 104, 106 of the light guide 102 that modifies a characteristic (e.g., spectrum, polarization, and/or intensity) of the light extracted through the major surface 104, 106 of the light guide 102. In one embodiment, the optical adjuster is a color attenuating material, a microlouver film, or a polarizer.

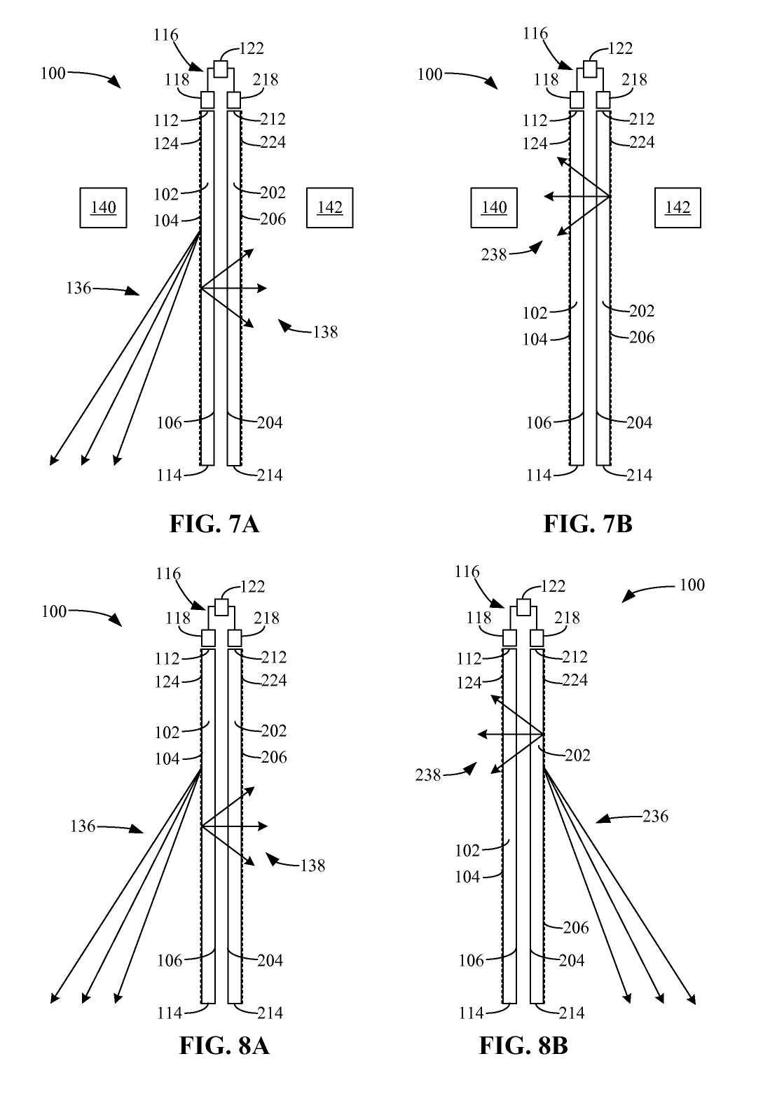

The embodiments described above include one transparent light guide 102. FIGS. 7-9 show examples of embodiments in which the lighting assembly 100 includes two transparent light guides 102, 202.

With reference to FIGS. 7A and 7B, the lighting assembly 100 includes a first transparent light guide 102 and a light source assembly 116 having one or more light sources 118, as described above in the various embodiments. The lighting assembly additionally includes a second transparent light guide 202 having a first major surface 204, a second major surface 206 opposite the first major surface 204, side edges, a light input edge 212, and an end edge 214. The first major surface 204 of the second light guide 202 faces the second major surface 106 of the first light guide 102 and is parallel thereto.

The lighting assembly 116 includes one or more light sources 218 positioned adjacent the light input edge 212 of the second light guide 202 and selectively operable to edge light the second light guide 202. Controller 122 is configured to respectively control the illumination state of the light sources 118, 218 (i.e., whether the light sources 118, 218 emit light or do not emit light). In some embodiments, the controller 122 is further configured to adjustably control the intensity of the light emitted from the light sources 118, 218 (i.e., dim or brighten the light sources 118, 218).

Referring to FIG. 7B, the second light guide 202 includes light extracting elements 224 at the second major surface 206 that are configured to extract light through the first major surface 204 of the second light guide 202 in a direction away from the first major surface 204 with a light ray angle distribution 238. The light extracted through the first major surface 204 of the second light guide 202 passes through the first light guide 102 with the light ray angle distribution 238, although some alteration of the light ray angle distribution 238 may occur when passing through the first light guide 102 due to refraction.

The lighting assembly 100 additionally has a defined viewing angle range relative to the first major surface 104 of the first light guide 102. The light ray angle distribution 238 is predominantly within the viewing angle range relative to the first major surface 104. In one example, light ray angle distribution 238 ranges from −45° to +45° relative to the normal to the first major surface 104 of the first light guide. In another example, light ray angle distribution 238 ranges from −30° to +60° relative to the normal to the first major surface 104.

The light extracted through the first major surface 204 of the second light guide 202 and passing through the first light guide 102 with the light ray angle distribution 238 reduces visibility through the lighting assembly 100 from the first major surface 104 of the first light guide 102 at viewing angles relative to the first major surface 104 within the viewing angle range. In other embodiments, depending on the light ray angle distribution 238, stray light additionally extracted through the first major surface 204 of the light guide 202 and passing through the light guide 102 reduces visibility through the lighting assembly 100 from the first major surface 104 of the first light guide 102 at viewing angles relative to the first major surface 104 outside the viewing angle range.

In addition to selective one-way viewing, controlling illumination of the first light guide 102 and/or the second light guide 202 (e.g., using controller 122) selectively controls the direction of the one-way viewing, and additionally provides the ability to selectively reduce visibility through the lighting assembly 100 in both directions.

When the first light guide 102 and the second light guide 202 are not illuminated, the first light guide 102 and the second light guide 202 are both transparent and visibility through the lighting assembly 100 from the first major surface 104 and from the second major surface 206 is not reduced.

In FIG. 7A, only the light sources 118 emit light and the first light guide 102 is illuminated. Light extracted through the second major surface 106 of the first light guide 102 passes through the non-illuminated, transparent second light guide 202 with the light ray angle distribution 138 in a direction away from the second major surface 206. Light extracted from the first light guide 102 through the first major surface 104 with the light ray angle distribution 136 is directed away from the first light guide 102 at low ray angles. The light extracting elements 124 of the first light guide 102 are configured such that illumination of only the first light guide 102 reduces visibility, at viewing angles within the viewing angle range relative to the second major surface 202, through the lighting assembly 100 from the second major surface 206 of the second light guide 202 by more than the light extracted from the first light guide 102 with the light ray angle distribution 136 reduces visibility, at a normal viewing angle relative to the first major surface 104, through the lighting assembly 100 from the first major surface 104 of the first light guide 102.

In FIG. 7B, only the light sources 218 emit light and the light guide 202 is illuminated. Light extracted through the first major surface 204 of the second light guide 202 having the light ray angle distribution 238 passes through the non-illuminated, transparent first light guide 102 in a direction away from the first major surface 104. The light extracting elements 224 of the light guide 202 are configured such that illumination of only the second light guide 202 reduces visibility through the lighting assembly 100 from the first major surface 104 of the light guide 102 at viewing angles within the viewing angle range relative to the first major surface 104. Light is not extracted through the second major surface 206 of the second light guide 202 and therefore does not reduce visibility through the lighting assembly 100 from the second major surface 206 of the second light guide 202. However, in some embodiments, some reduction in visibility does occur due to stray light additionally extracted through the second major surface 206.

Illumination of both the first light guide 102 and the second light guide 202 reduces visibility through the lighting assembly 100 at viewing angles within the viewing angle range relative to the first major surface 104 and relative to the second major surface 206. Light extracted through the second major surface 106 of the first light guide 102 having the light ray angle distribution 138 passes through the second light guide 202 in a direction away from the second major surface 206, thereby reducing visibility through the lighting assembly 100 from the second major surface 206 at viewing angles relative to the second major surface 206 within the viewing angle range. Light extracted through the first major surface 204 of the second light guide 202 having the light ray angle distribution 238 passes through the first light guide 102 in a direction away from the first major surface 104 and reduces visibility through the lighting assembly 100 from the first major surface 104 at viewing angles relative to the first major surface 104 within the viewing angle range.

In an example, when the first light guide 102 and the second light guide 202 are not illuminated, an object 140 on the first side of the lighting assembly 100 is visible through the lighting assembly 100 when viewed from the second side of the lighting assembly; and an object 142 on the second side of the lighting assembly 100 is visible through the lighting assembly 100 when viewed from the first side of the lighting assembly 100. The light extracting elements 124 are configured such that, when only the first light guide 102 is illuminated, the object 140 on the first side of the lighting assembly 100 is not visible through the lighting assembly 100 when viewed at a viewing angle within the viewing angle range relative to the second side of the lighting assembly 100. However, the object 142 on the second side of the lighting assembly 100 is visible through the lighting assembly 100 when viewed at a normal viewing angle relative to the first side of the lighting assembly 100.

The light extracting elements 224 are configured such that, when only the second light guide 202 is illuminated, the object 142 on the second side of the lighting assembly 100 is not visible through the lighting assembly 100 when viewed at a viewing angle within the viewing angle range relative to the first side of the lighting assembly 100. However, the object 140 on the first side of the lighting assembly 100 is visible through the lighting assembly 100 when viewed at a normal viewing angle relative to the second side of the lighting assembly 100. The light extracting elements 124, 224 are configured such that, when both the first light guide 102 and the second light guide 202 are illuminated, the object 140 is not visible through the lighting assembly 100 when viewed from the second side of the lighting assembly 100 within the viewing angle range relative to the second side of the lighting assembly 100, and the object 142 is not visible through the first light guide 102 and the second light guide 202 when viewed from the first side of the lighting assembly 100 within the viewing angle range relative to the first side of the lighting assembly 100.

FIGS. 8A and 8B illustrate an embodiment of the lighting assembly 100 that is similar to the embodiment of FIGS. 7A and 7B. The lighting assembly 100 includes light extracting elements 224 configured to additionally extract light through the second major surface 206 of the second light guide 202 with a ray angle distribution 236 to provide task lighting similar to that provided by the light extracted from the first light guide 102 with the light ray angle distribution 136.

In FIG. 8A, only the light guide 102 is illuminated and the light extracting elements 124 of the first light guide 102 are configured to extract light in a similar manner to that described above in relation to FIG. 7A. In FIG. 8B, only the second light guide 202 is illuminated. The light extracting elements 224 of the second light guide 202 are configured such that light is extracted through the second major surface 206 of the light guide 202 with the light ray angle distribution 236 in addition to the light extracted through the first major surface 204 with the light ray angle distribution 238. Light ray angle distribution 236 includes ray angles predominantly at low angles relative to the second major surface 206 and is narrower than light ray angle distribution 238. Light extracted through the second major surface 206 with the light ray angle distribution 236 is directed away from the second light guide 202 at low ray angles outside a normal viewing angle relative to the second major surface 206, and does not reduce visibility through the lighting assembly 100 at the normal viewing angle relative to the second major surface 206. In some embodiments, the light extracted through the second major surface 206 having the light ray angle distribution 236 is incident on a region of a target surface (not shown) in a manner similar to the light with the light ray angle distribution 136 described above with reference to FIG. 2.

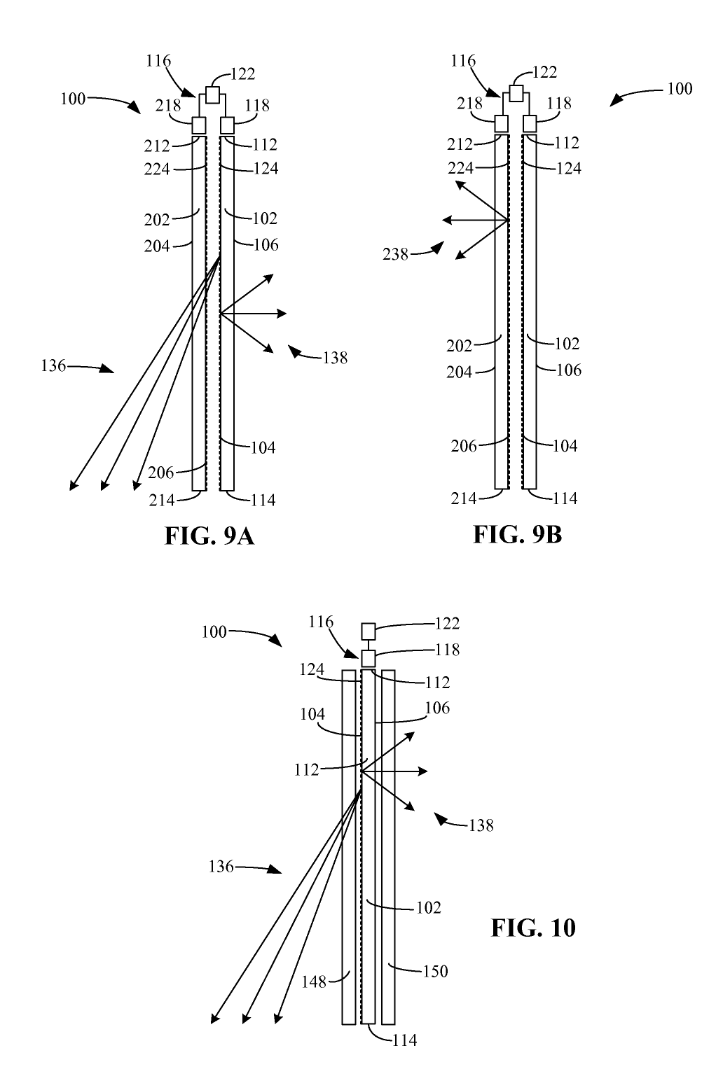

FIGS. 9A and 9B show another arrangement of the lighting assembly 100 including the two transparent light guides 102, 202, wherein the second major surface 206 of the second light guide 202 faces the first major surface 104 of the first light guide 102 and is typically parallel thereto.

In FIG. 9A, only the first light guide 102 is illuminated. Light extracted through the second major surface 106 of the first light guide 102 with the light ray angle distribution 138 is directed away from the light guide 102 in a direction away from the second major surface 206. Such light reduces visibility through the lighting assembly 100 at a viewing angle within the viewing angle range relative to the second major surface 106 of the first light guide 102. Light extracted through the first major surface 104 from the first light guide 102 having the light ray angle distribution 136 passes through the non-illuminated, transparent second light guide 202 at low ray angles outside a normal viewing angle relative to the first major surface 206, and does not reduce visibility through the lighting assembly 100 at the normal viewing angle relative to the first major surface of the second light guide 202. Part of the low angle light extracted through the first major surface 104 from the light guide 102 is reflected at the first major surface of the second light guide 202 instead of passing through the second light guide 202. To minimize this reflection, the light may be extracted at a higher angle relative to the first major surface 104 (e.g., about 45° relative to the first major surface 104), or an antireflective coating may be applied to the second major surface 206 of the second light guide 202.

In FIG. 9B only the second light guide 202 is illuminated. Light extracted through the first major surface 204 having the light ray angle distribution 238 is directed away from the second light guide 202 in a direction away from the first major surface 204. Such light reduces visibility through the lighting assembly 100 at a viewing angle within the viewing angle range relative to the first major surface 204 of the second light guide 202. Light is not extracted through the second major surface 206 of the second light guide 202 and therefore does not reduces visibility through the lighting assembly 100 from the second major surface 106 of the first light guide 102. In other embodiments, the light extracting elements 224 of the second light guide are configured to additionally extract light through the second major surface 206 of the second light guide 202 at low ray angles to provide task lighting, in a similar manner to that described above in relation to FIG. 8B.

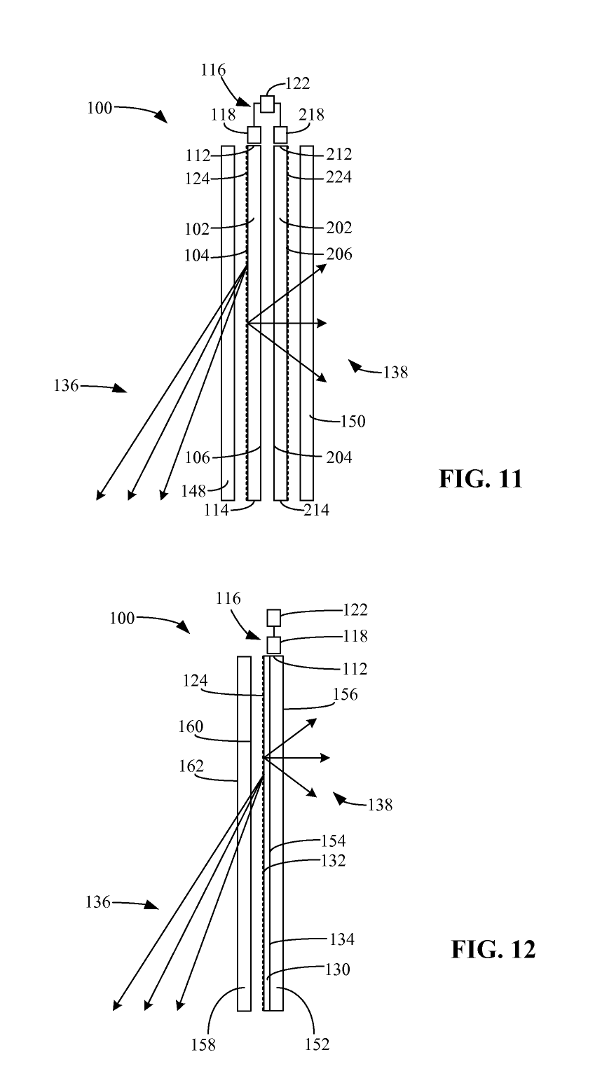

Referring now to FIGS. 10 and 11, embodiments of the lighting assembly 100 may include one or more transparent members 148, 150 positioned adjacent the major surface of a light guide. In one example, the one or more light guides 102, 202 and the one or more transparent members 148, 150 are embodied as panes of a window. In another example, the transparent members 148, 150 are protective layers that protect the major surfaces 104, 106 of the light guide 102 from damage from scratches, weathering, and the like. FIG. 10 shows a lighting assembly 100 that includes transparent members 148, 150 respectively adjacent the first major surface 104 and the second major surface 106 of the light guide 102. FIG. 11 shows a lighting assembly 100 that includes transparent member 148 adjacent the first major surface 104 of the first light guide 102, and transparent member 150 adjacent the second major surface 204 of the second light guide 202. In other embodiments, the lighting assembly 100 includes only one transparent member 148 or 150.

The transparent members 148, 150 are made from, for example, one or more layers of acrylic, polycarbonate, glass, or other appropriate material. In one example, the transparent members 148, 150 are specularly transmissive and incident light is considered to pass therethrough without optical modification, even though specularly transmissive material refracts light that passes through a surface of the material at a non-zero angle of incidence. In another example, at least one of the transparent members includes one or more of a color attenuating material, a microlouver film, and a polarizer.

In another embodiment, a light extracting member 130 is optically bonded to a major surface of one of the panes of a conventional glass window (e.g., single pane window, double pane window, triple pane window). FIG. 12 shows a light extracting member 130 embodied as a film that is optically bonded to the inner surface 154 of the outer pane 152 of a standard double-pane glass window. The inner pane 158 includes an inner surface 162 and an outer surface 160, and the outer pane 152 includes an inner surface 154 and an outer surface 156. A light source assembly 116 including one or more light sources 118 is positioned adjacent an edge of the outer pane 152, and the outer pane 152 to which the light extracting member 130 is optically bonded functions as a slab light guide similar to the slab light guide 103 described above with reference to FIG. 6.

In FIG. 12, the light sources 118 emit light and the outer pane 152 is illuminated. Light propagating in the outer pane 152 exits the outer pane 152 through the inner surface 154 and enters the light extracting member 130 through the second major surface 134 of the light extracting member 130. The light extracting elements 124 are configured to extract light by reflection through the second major surface 134 of the light extracting member 130 and the inner surface 154 and the outer surface 156 of the outer pane 152 in a direction away from the outer surface 156. Light extracted through the outer surface 156 of the outer pane 152 is directed away from the outer pane 152 with the light ray angle distribution 138. Such light reduces visibility through the lighting assembly 100 at a viewing angle within the viewing angle range relative to the outer surface 156 of the outer pane 152.

The light extracting elements 124 are also configured to extract light received through the second major surface 134 of the light extracting member 130 by refraction in a direction away from the light input edge 112 and the first major surface 132. Light extracted through the first major surface 132 with the light ray angle distribution 136 passes through the non-illuminated, transparent inner pane 158 at low ray angles outside a normal viewing angle relative to the inner surface 162 of the inner pane 158. The light with the light ray angle distribution 136 provides task lighting, as described above with reference to FIG. 2, and does not reduce visibility through the lighting assembly 100 at the normal viewing angle relative to the inner surface 162 of the inner pane 158. Part of the low angle light extracted through the first major surface 132 is reflected at the outer surface 160 of the inner pane 158 instead of passing through the inner pane 158. To minimize this reflection, the light may be extracted at a higher angle relative to the outer surface 160 of the inner pane 158, or antireflective coating may be applied to the outer surface 160 of the inner pane 158.

The lighting assembly 100, as described above in the various embodiments, is configurable for use in various applications.

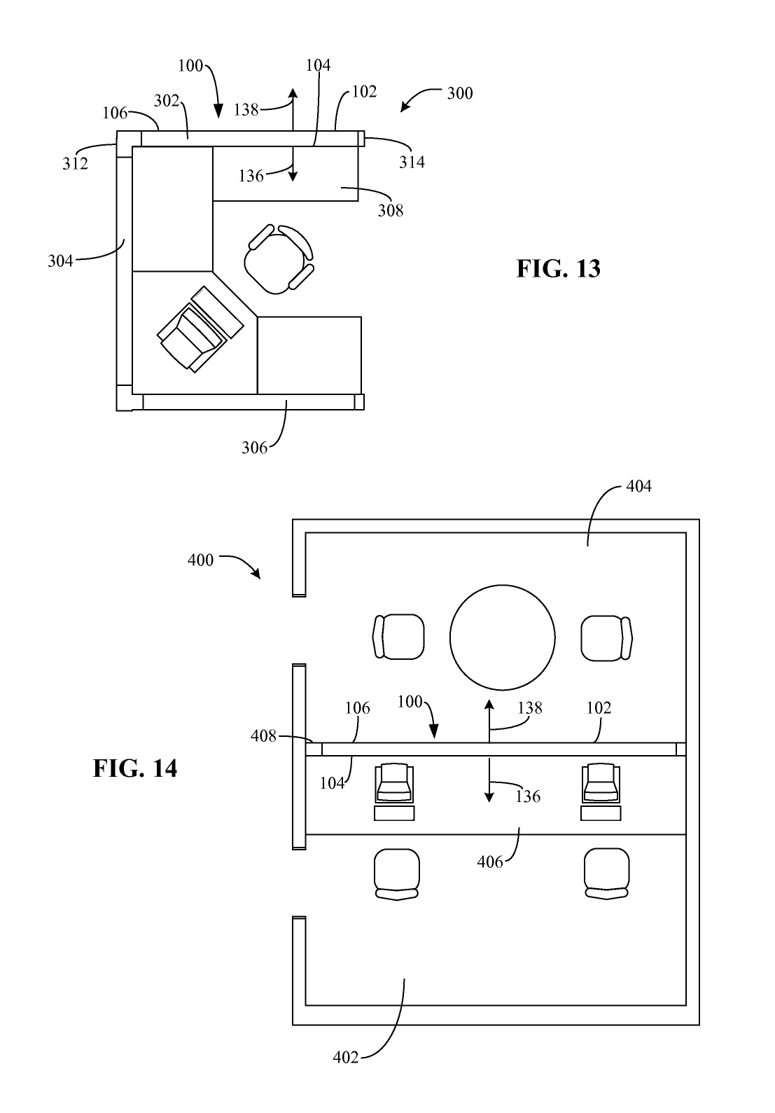

FIG. 13 is a floor plan showing an exemplary application of the lighting assembly 100 as a wall panel of a cubicle 300. The lighting assembly 100 serves as a wall panel 302 of the cubicle 300 and is supported by structural members 312, 314. Wall panels 304 and 306 do not include lighting assemblies. In some embodiments, more than one wall panel of the cubicle 300 includes a lighting assembly. In other embodiments, a lighting assembly 100 is a portion of a wall panel of the cubicle 300.

When the light guide 102 of the lighting assembly 100 is not illuminated, the lighting assembly 100 is transparent. Therefore, the interior of the cubicle 300 is visible through the lighting assembly 100 from outside the cubicle 300. Objects and individuals outside the cubicle 300 are also visible through the lighting assembly 100 from the interior of the cubicle 300.

When the light guide 102 of the lighting assembly 100 is illuminated, light is extracted through the second major surface 106 with a light ray angle distribution 138 that reduces visibility through the lighting assembly 100 from outside the cubicle 300 at viewing angles relative to the second major surface 106 within the viewing angle range. Therefore, when the lighting assembly 100 is illuminated, objects and individuals within the cubicle 300 are not visible or have a reduced visibility when viewed through the lighting assembly 100 from the exterior of the cubicle 300.

Light is also extracted through the first major surface 104 with a light ray angle distribution predominantly at low angles relative to the first major surface 104. This light provides task lighting for a work surface 308 of the cubicle 300. Illumination of the light guide 102 does not reduce visibility at a normal viewing angle relative to the first major surface 104. Therefore, when the lighting assembly 100 is illuminated, objects and individuals outside the cubicle 300 are visible from inside the cubicle 300.

FIG. 14 is a floor plan showing an exemplary application of the lighting assembly 100 embodied as a window. The lighting assembly 100 is installed in a wall 408 that divides two rooms 402, 404 and is configured as one or more windowpanes.

When the light guide 102 of the lighting assembly 100 is not illuminated, the lighting assembly 100 is transparent. Therefore, room 402 is visible through the lighting assembly 100 from room 404. Furthermore, room 404 is visible through the lighting assembly 100 from room 402.

When the light guide 102 of the lighting assembly 100 is illuminated, light is extracted through the second major surface 106 with a light ray angle distribution 138 that reduces visibility through the lighting assembly 100 from the room 404 at viewing angles relative to the second major surface 106 within the viewing angle range. Therefore, when the lighting assembly 100 is illuminated, objects within the room 402 are not visible or have a reduced visibility when viewed through the lighting assembly 100 from room 404. The light extracted through the second major surface 106 also provides ambient lighting for room 404.

Light is also extracted through the first major surface 104 with a light ray angle distribution predominantly at low angles relative to the first major surface 104. This light provides task lighting for a work surface 406. Illumination of the light guide 102 does not reduce visibility at a normal viewing angle relative to the first major surface 104. Therefore, when the lighting assembly 100 is illuminated, objects and individuals within room 404 are visible when viewed from room 402.

Other applications are apparent based on using any of the above-noted embodiments.

In this disclosure, the phrase “one of” followed by a list is intended to mean the elements of the list in the alternative. For example, “one of A, B and C” means A or B or C. The phrase “at least one of” followed by a list is intended to mean one or more of the elements of the list in the alternative. For example, “at least one of A, B and C” means A or B or C or (A and B) or (A and C) or (B and C) or (A and B and C).

What is claimed is:

1. A lighting assembly, comprising:
a transparent light guide to propagate light by total internal reflection, the light guide having a first major surface, a second major surface opposite the first major surface, and a light input edge;
a light source located adjacent the light input edge, the light source selectively operable to edge light the light guide with visible light;
first light extracting elements at the first major surface of the light guide, the first light extracting elements configured to extract light through the first major surface with a first light ray angle distribution directed away from the light input edge and the first major surface; and
second light extracting elements at the first major surface of the light guide, the second light extracting elements configured to extract light through the second major surface with a second light ray angle distribution directed away from the second major surface and predominantly within a defined viewing angle range relative to the second major surface,
wherein the light extracting elements are configured such that light emitted from the light source and extracted from the light guide through the second major surface reduces visibility, at viewing angles within the viewing angle range relative to the second major surface, through the lighting assembly from the second major surface of the light guide compared with the visibility when the light guide is not illuminated by the light source; and wherein the light extracted from the light guide through the second major surface reduces the visibility, at viewing angles within the viewing angle range relative to the second major surface, through the lighting assembly from the second major surface of the light guide by more than the light extracted through the first major surface reduces visibility, at a normal viewing angle relative to the first major surface, through the lighting assembly from the first major surface of the light guide.

2. The lighting assembly of claim 1, wherein the second light ray angle distribution has a range of angles that is wider than a range of angles of the first light ray angle distribution.

3. The lighting assembly of claim 1, wherein the first light extracting elements and the second light extracting elements are configured such that illumination of the light guide by the light source does not reduce the visibility through the lighting assembly from the first major surface of the light guide at the normal viewing angle.

4. The lighting assembly of claim 1, wherein:
an object closer to the first major surface of the light guide than to the second major surface of the light guide is on a first side of the lighting assembly, and an object closer to the second major surface of the light guide than to the first major surface of the light guide is on a second side of the lighting assembly; and
the first light extracting elements and the second light extracting elements are configured such that, when the light guide is illuminated by the light source:
the object on the first side of the lighting assembly is not visible through the light guide from the second side of the lighting assembly at viewing angles within the viewing angle range relative to the second major surface of the light guide; and
the object on the second side of the lighting assembly is visible through the light guide from the first major surface of the light guide at the normal viewing angle relative to the first major surface of the light guide.

5. The lighting assembly of claim 1, wherein the first light ray angle distribution comprises ray angles predominantly at low angles relative to the first major surface.

6. The lighting assembly of claim 1, wherein the second light ray angle distribution is predominantly closer to normal to the second major surface than the first light ray angle distribution is to normal to the first major surface.

7. The lighting assembly of claim 1, wherein the first light extracting elements comprise micro-optical elements, and the second light extracting elements comprise micro-optical elements different from the first light extracting elements.

8. The lighting assembly of claim 1, wherein the first light extracting elements comprise micro-optical elements, and the second light extracting elements comprise reflective elements.

9. The lighting assembly of claim 8, wherein the reflective elements comprise a diffusive surface.

10. The lighting assembly of claim 1, wherein the first light extracting elements and the second light extracting elements are integral with one another and are micro-optical elements configured to extract light through the first major surface, and to extract light through the second major surface.

11. The lighting assembly of claim 1, wherein the light guide comprises a slab light guide and a light extracting member optically bonded to a major surface of the slab light guide, the light extracting member comprising the first light extracting elements and the second light extracting elements.

12. The lighting assembly of claim 11, wherein the light extracting member is embodied as a film.

13. The lighting assembly of claim 1, wherein the light guide comprises at least one of polycarbonate, acrylic, polymethylmethacrylate, and glass.

14. The lighting assembly of claim 1, wherein the light source comprises a solid state light source.

15. The lighting assembly of claim 14, wherein the solid state light source comprises a light emitting diode.

16. The lighting assembly of claim 1, additionally comprising an optical adjuster adjacent at least one of the major surfaces of the light guide to modify at least one of spectrum, polarization, light ray angle distribution, and intensity of the light extracted through the adjacent major surface.

17. The lighting assembly of claim 1, further comprising a controller configured to control illumination of the light source.

18. The lighting assembly of claim 1, wherein the lighting assembly is configured to illuminate a target surface, and the first light extracting elements are configured to direct the light extracted through the first major surface toward the target surface.

19. The lighting assembly of claim 1, further comprising a transparent member located adjacent one of the major surfaces of the light guide, wherein the transparent member comprises at least one of polycarbonate, acrylic, polymethylmethacrylate, and glass.

20. The lighting assembly of claim 1, wherein:
the light guide is a first light guide and the light source is a first light source; and
the lighting assembly additionally comprises:
a second transparent light guide to propagate light by total internal reflection, the second light guide having a first major surface, a second major surface opposite the first major surface, and a light input edge, wherein one of the major surfaces of the second light guide faces one of the major surfaces of the first light guide;
a second light source located adjacent the light input edge of the second light guide, the second light source selectively operable to edge light the second light guide with visible light; and
third light extracting elements at the second major surface of the second light guide, the third light extracting elements configured to extract light through the first major surface of the second light guide with a third light ray angle distribution directed away from the first major surface of the second light guide.

21. The lighting assembly of claim 20, wherein:
the second major surface of the first light guide faces the first major surface of the second light guide; and
the third light extracting elements are configured such that light emitted from the second light source and extracted through the first major surface of the second light guide passes through the first light guide and reduces visibility, at viewing angles within a viewing angle range relative to the first major surface of the light guide, through the lighting assembly from the first major surface of the first light guide compared with the visibility when the second light guide is not illuminated by the second light source; and
wherein the light extracted through the first major surface of the second light guide reduces the visibility through the lighting assembly from the first major surface of the first light guide, at viewing angles within a viewing angle range relative to the first major surface of the first light guide, by more than a reduction in visibility, at a normal viewing angle relative to the second major surface of the second light guide, through the lighting assembly from the second major surface of the second light guide.

22. The lighting assembly of claim 21, wherein:
an object closer to the first major surface of the first light guide than to the second major surface of the second light guide is on a first side of the lighting assembly, and an object closer to the second major surface of the second light guide than to the first major surface of the first light guide is on a second side of the lighting assembly; and
the first light extracting elements, the second light extracting elements, and the third light extracting elements are configured such that, during illumination of the first light guide by the first light source and not of the second light guide:
the object on the first side of the lighting assembly is not visible through the lighting assembly when viewed from the second side of the lighting assembly at viewing angles within the viewing angle range; and
the object on the second side of the lighting assembly is visible through the lighting assembly when viewed from the first side of the lighting assembly at the normal viewing angle.

23. The lighting assembly of claim 21, wherein:
an object closer to the first major surface of the first light guide than to the second major surface of the second light guide is on a first side of the lighting assembly, and an object closer to the second major surface of the second light guide than to the first major surface of the first light guide is on a second side of the lighting assembly; and
the first light extracting elements, the second light extracting elements, and the third light extracting elements are configured such that, during illumination of the second light guide by the second light source and not of the first light guide:
the object on the second side of the lighting assembly is not visible through the lighting assembly when viewed from the first side of the lighting assembly at viewing angles within the viewing angle range; and
the object on the first side of the lighting assembly is visible through the lighting assembly when viewed from the second side of the lighting assembly at the normal viewing angle.

24. The lighting assembly of claim 20, wherein the second light guide further comprises fourth light extracting elements at the second major surface, the fourth light extracting elements configured to extract light through the second major surface of the second light guide with a fourth light ray angle distribution directed away from the light input edge and the second major surface of the second light guide.

25. The lighting assembly of claim 24, wherein the fourth light ray angle distribution comprises ray angles predominantly at low angles relative to the second major surface of the second light guide.

26. The lighting assembly of claim 24, wherein the third light ray angle distribution is predominantly closer to normal to the first major surface of the second light guide than the fourth light ray angle distribution is to normal to the second major surface of the second light guide.

27. The lighting assembly of claim 20, further comprising a controller configured to selectively control illumination of the first light source and the second light source.

28. A wall panel comprising a lighting assembly in accordance with claim 1; and
a structural member that supports the lighting assembly.

29. A window comprising a lighting assembly in accordance with claim 1.

30. A light extracting member configured for optically bonding to a major surface of a slab light guide, the slab light guide configured for edge lighting at a light input edge, the light extracting member comprising:
a first major surface and a second major surface opposite the first major surface, the second major surface configured for optically bonding to the slab light guide to receive light therefrom;
first light extracting elements at the first major surface of the light extracting member, the first light extracting elements configured to extract light received from the slab light guide, the first light extracting elements extracting the light through the first major surface of the light extracting member with a first light ray angle distribution directed away from the light input edge and the first major surface; and
second light extracting elements at the first major surface of the light extracting member, the second light extracting elements configured to extract light received from the slab light guide, the second light extracting elements extracting the light through the second major surface of the light extracting member with a second light ray angle distribution directed away from the second major surface and predominantly within the viewing angle range relative to the second major surface.

31. The light extracting member of claim 30, wherein the first light ray angle distribution comprises ray angles predominantly at low angles relative to the first major surface.

32. The light extracting member of claim 30, wherein the second light ray angle distribution is predominantly closer to normal to the second major surface than the first light ray angle distribution is to normal to the first major surface.

33. The light extracting member of claim 30, wherein the first light extracting elements comprise micro-optical elements, and the second light extracting elements comprise reflective elements.

34. The light extracting member of claim 30, wherein the reflective elements comprise a diffusive surface.

35. The light extracting member of claim 30, wherein the first light extracting elements and the second light extracting elements are integral with one another and are micro-optical elements configured to extract light through the first major surface, and to extract light through the second major surface.

36. The light extracting member of claim 30, wherein the light extracting member is embodied as a film.
